(19) United States
(12) Patent Application Publication
(10) Pub. No.: US 2015/0100490 A1
(43) Pub. Date: Apr. 9, 2015

(54) COMPUTER-BASED METHOD FOR LINKING USER ACCOUNT INFORMATION FROM A MOBILE COMPUTING DEVICE

(71) Applicant: Xsolla (USA) Inc., Sherman Oaks, CA (US)

(72) Inventor: Aleksandr Agapitov, Sherman Oaks, CA (US)

(73) Assignee: Xsolla (USA) Inc., Sherman Oaks, CA (US)

(21) Appl. No.: 14/047,814

(22) Filed: Oct. 7, 2013

(51) Int. Cl. G06Q 20/14; G06Q 30/04; G06Q 20/40

(52) U.S. Cl. CPC G06Q 20/14; G06Q 20/40; G06Q 30/04
USPC 705/44; 705/39

(57) ABSTRACT

A computer-based method for linking user account information for making future payments. The method may comprise the steps of: providing an application and a server application; displaying the application through a display screen and prompting the user to input a phone number of a mobile computing device into the application via an input device; receiving the phone number from the user and sending the phone number to the server application; generating and transmitting a text message with a uniform resource locator (URL) link from the server application to the mobile computing device based on the phone number; prompting the user to open the URL link; opening a webpage in a web browser in the mobile computing device when the user opens the URL link; prompting the user to input user account information into the webpage; receiving the user account information from the user; and saving the user account information in the server.

### FIELD OF THE INVENTION

The present invention generally relates to a computer-based method for linking user account information, and more particularly, the invention generally relates to a method for linking user account information from a mobile computing device such as a cellular phone or smartphone to a server application for future payments.

### BACKGROUND OF THE INVENTION

Online payments for services and products in online games have experienced a tremendous amount of growth since the advent of the Internet. Aside from the convenience of making a payment from a person's home, more people and online gamers are leaning towards payments that are often safe and easy. Thus, while there may be some risks associated with making an online purchase, the use of encryption, security keys, and “captchas” have helped prevent hackers and identity thieves from compromising financial information.

Although the world of online purchasing has grown exponentially, especially for online games, making an initial online purchase can still be a time consuming process, especially if an individual must initially create a new account or repeatedly input his or her information for a later purchase. Furthermore, errors are frequently made during the process of entering user account information. While some software applications auto-populate a person's information, this generally requires a user to utilize the same computer or workstation that was previously used to enter such user account information.

In other situations, an individual engaged in playing a software application, such as an online video game, may also want to make a purchase within the confines of playing that videogame. Unfortunately, this may be problematic or time consuming because that person may have to first logout the game, input his or her user account information, and then reenter the game, to finally be able to make that online purchase. Another problem that frequently occurs when making an online payment is that most people generally have multiple billing accounts or payment methods. Thus, the rising popularity of using multiple user accounts, such as a cell phone billing account, an online banking account, user website generated profiles, and credit cards, has reached a point to where many individuals have begun to lose track of their accounts and the passwords connected to these accounts. As such, it would be beneficial to save payment or user account information for a particular software application without the need of remembering which payment method was made for a particular account.

Therefore, based on the foregoing, there is a need for a system and method that overcomes the deficiencies of recreating online user accounts that are currently available. The present invention solves these deficiencies and generally represents a new and useful innovation in the space of linking online user accounts for future payments.

### SUMMARY OF THE INVENTION

To minimize the limitations in the prior art, and to minimize other limitations that will become apparent upon reading and understanding the present specification, the present invention discloses a new and useful computer-based method for linking user account information on a mobile computing device.

One embodiment of the new method is a method for linking user account information for making future payments, the computer-implemented steps comprising: providing an application and a server application; wherein the application is configured to run on an electronic data processing unit; wherein the server application is configured to run on a server; wherein the application is configured to access the server application through a network; displaying the application through a display screen of the electronic data processing unit to a user; prompting the user by the application to input a phone number of a mobile computing device into the application via an input device; receiving, by the application the phone number from the user; sending the phone number by the application to the server application; receiving by the server application the phone number from the user; generating and transmitting a text message from the server application to the mobile computing device based on the phone number; wherein the text message comprises a uniform resource locator (URL) link; prompting the user to open the URL link; opening a webpage in a web browser in the mobile computing device when the user opens the URL link; prompting the user to input a user account information into the webpage; receiving the user account information from the user by the server application when the user inputs the user account information into the webpage; and saving the user account information in the server. The application may be an online game. The electronic data processing unit may be a gaming console. The receiving step of the phone number of the user by the server application may further comprise the steps of: receiving, by the application the phone number from the user; and sending the phone number by the application to the server application. The method may further comprise the step of: validating the payment of the user by the server application. The user account information may be used to make one or more future payments through the application. The steps may further comprise: sending a payment authorization request to the user by the application; wherein the payment authorization request allows the application to process one or more future payments based on the saved user account information of the user. The user account information may comprise a billing information of the user. The user account information may comprise a contact information of the user. The mobile computing device may be selected from the group of mobile computing devices consisting of: a cellphone; a tablet computer; and a smartphone. The input device may be selected from the group of input devices consisting of: a remote control; a keyboard; a video game controller; and a mouse.

Another embodiment of the new method is a method for linking user account information for making future payments, the computer-implemented steps comprising: providing an application and a server application; wherein the application is configured to run on an electronic data processing unit; wherein the server application is configured to run on a server; wherein the application is configured to access the server application through a network; displaying the application through a display screen of the electronic data processing unit to a user; prompting the user by the application to input a phone number of a mobile computing device into the application via an input device; receiving, by the application the phone number from the user; sending the phone number by the application to the server application; receiving by the server application the phone number of the user; generating and transmitting a text message from the server application to the mobile computing device based on the phone number; wherein the text message comprises a uniform resource locator (URL) link; prompting the user to open the URL link; opening a webpage in a web browser in the mobile computing device when the user opens the URL link; prompting the user to input a user account information into the webpage in order to make a payment; receiving the user account information from the user by the server application when the user inputs the user account information into the webpage to make the payment; saving the user account information in the server; and creating a user account based on the saved user account information in the server; wherein the user account is used to make one or more future payments through the application. The application may be an online game. The electronic data processing unit may be a gaming console. The steps may further comprise: sending a payment authorization request to the user by the application; wherein the payment authorization request allows the application to process the one or more future payments based on the user account of the user. The user account information may comprise a billing information of the user. The user account information may comprise a contact information of the user. The mobile computing device may be selected from the group of mobile computing devices consisting of: a cellphone; a tablet computer; and a smartphone. The input device may be selected from the group of input devices consisting of: a remote control; a keyboard; a video game controller; and a mouse.

Another embodiment of the new method is a method for linking user account information for making future payments, the computer-implemented steps comprising: providing an online game and a server application; wherein the online game is configured to run on an gaming console; wherein the server application is configured to run on a server; wherein the online game is configured to access the server application through a network; displaying the online game through a display screen of the gaming console to a user; prompting the user by the online game to input a phone number of a mobile computing device into the online game via an input device; receiving the phone number from the user; sending the phone number by the online game to the server application; receiving by the server application the phone number of the user; generating and transmitting a text message from the server application to the mobile computing device based on the phone number; wherein the text message comprises a uniform resource locator (URL) link; prompting the user to open the URL link; opening a webpage in a web browser in the mobile computing device when the user opens the URL link; prompting the user to input a user account information into the webpage in order to make a payment; receiving the user account information from the user by the server application when the user inputs the user account information into the webpage to make the payment; saving the user account information in the server; sending a payment authorization request to the user by the online game; wherein the payment authorization request allows the online game to process the one or more future payments based on the user account information of the user; wherein the user account information comprises a billing information of the user; wherein the user account information comprises a contact information of the user; wherein the mobile computing device is selected from the group of mobile computing devices consisting of: a cellphone; a tablet computer; and a smartphone; and wherein the input device is selected from the group of input devices consisting of: a remote control; a keyboard; a video game controller; and a mouse.

It is an object of the method to save user account information from a mobile computing device to a server application for future payments.

It is an object of the method to provide a user with the ability to make future payment on an application based upon saved user account information.

It is an object of the method to allow a user to consolidate their payment methods.

It is an object of the method to save a user account from a mobile computing device to a server.

It is another object of the method to provide payment options that are uniquely tailored to each user.

It is an object of the new method and system to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the computer-based method for linking user account information from a mobile computing device.

FIG. 2 is a functional flow diagram of one embodiment of the system for linking user account information from a mobile computing device.

FIG. 3 is a screenshot of one embodiment of the application of the electronic data processing unit and shows the application prompting the user to input a phone number of a mobile computing device.

FIG. 4 is an illustration of one embodiment of a mobile computing device and shows a text message with a URL link sent by the server application.

FIG. 5 is an illustration of another embodiment of a mobile computing device and shows a webpage where a user may enter user account information.

FIG. 6 is a screenshot of another embodiment of the application of the electronic data processing unit and shows that the user account information populated in the application by the server.

### DETAILED DESCRIPTION OF THE INVENTION

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

### DEFINITIONS

In the following description, certain terminology is used to describe certain features of one or more embodiments of the invention. For example, as used herein, the terms “mobile computing device”, “device”, “computer”, “electronic data processing unit”, or “server” refers to any device that processes information with an integrated circuit chip, including without limitation, personal computers, mainframe computers, workstations, servers, desktop computers, portable computers, laptop computers, embedded computers, wireless devices including cellular phones, personal digital assistants, tablets, tablet computers, smartphones, portable game players, and hand-held computers.

As used herein, the term “Internet” generally refers to any collection of networks that utilizes standard protocols, whether Ethernet, Token ring, Wifi, asynchronous transfer mode (ATM), Fiber Distributed Data Interface (FDDI), code division multiple access (CDMA), global systems for mobile communications (GSM), long term evolution (LTE), or any combination thereof. The term “website” refers to any document written in a mark-up language including, but not limited to, hypertext mark-up language (HTML) or virtual reality modeling language (VRML), dynamic HTML, extended mark-up language (XML), wireless markup language (WML), or any other computer languages related thereto, as well as to any collection of such documents reachable through one specific Internet Protocol Address or at one specific World Wide Web site, or any document obtainable through any particular Uniform Resource Locator (URL).

As used herein, the terms “webpage”, “page”, “website”, or “site” generally refers to any of the various documents and resources on the World Wide Web, in HTML/XHTML format with hypertext links to enable navigation from one page or section to another, or similar such resources used on the Internet.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “future payment” generally refers to any future financial transaction for an online service or good that is made through a server application using user account information that has been linked or saved from a mobile computing device.

The computer-based method proposed by the present invention is preferably an application and server application that allows a user to link user account information from a mobile computing device to the server application. The method preferably comprises the following steps: providing an application and a server application; displaying the application through a display screen of the electronic data processing unit to a user; prompting the user by the application to input a phone number of a mobile computing device into the application via an input device; receiving the phone number from the user; sending the phone number by the application to the server application; generating and transmitting a text message from the server application to the mobile computing device based on the phone number; wherein the text message generally comprises a uniform resource locator (URL) link; prompting the user to open the URL link; opening a webpage in a web browser in the mobile computing device when the user opens the URL link; prompting the user to input a user account information into the webpage; receiving the user account information from the user by the server application when the user inputs the user account information into the webpage; and saving the user account information in the server.

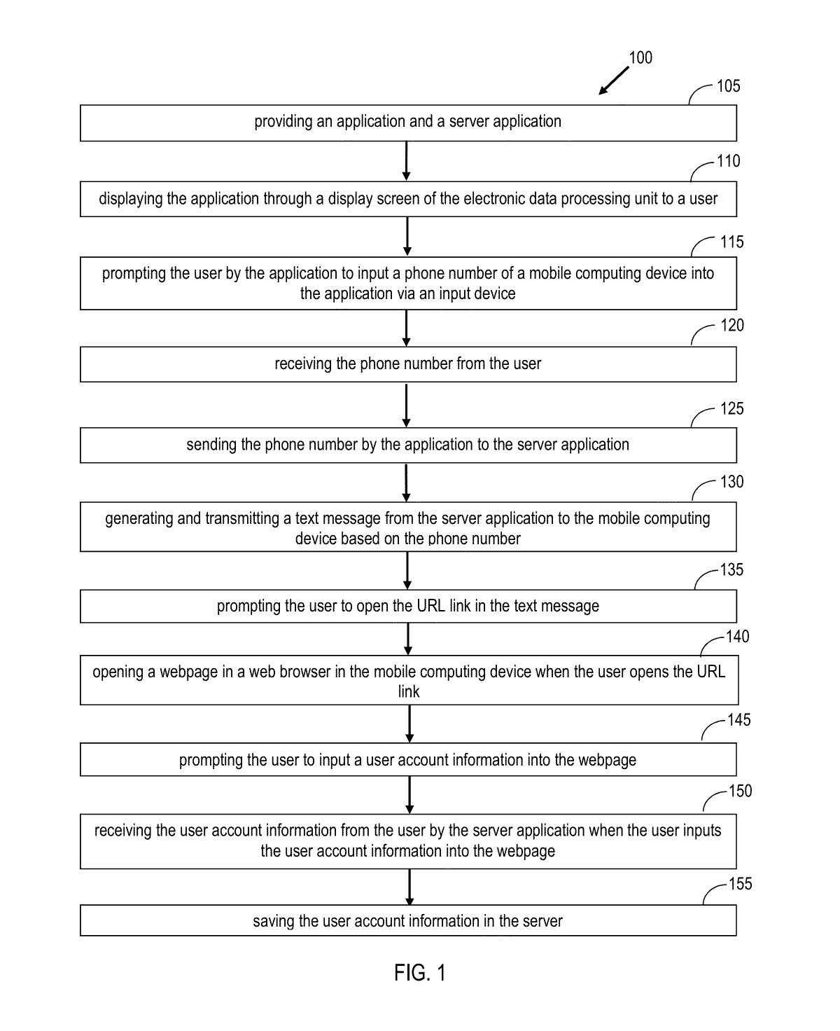

FIG. 1 is a flow chart of one embodiment of the computer-based method for linking user account information from a mobile computing device. As shown in FIG. 1, one embodiment of the method 100 for linking user account information for making future payments may comprise the steps of: providing an application and a server application 105; displaying the application through a display screen of the electronic data processing unit to a user 110; prompting the user by the application to input a phone number of a mobile computing device into the application via an input device 115; receiving the phone number from the user 120; sending the phone number by the application to the server application 125; generating and transmitting a text message from the server application to the mobile computing device based on the phone number 130; prompting the user to open the URL link in the text message 135; opening a webpage in a web browser in the mobile computing device when the user opens the URL link 140; receiving the user account information from the user by the server application when the user inputs the user account information into the webpage 150; and saving the user account information in the server 155.

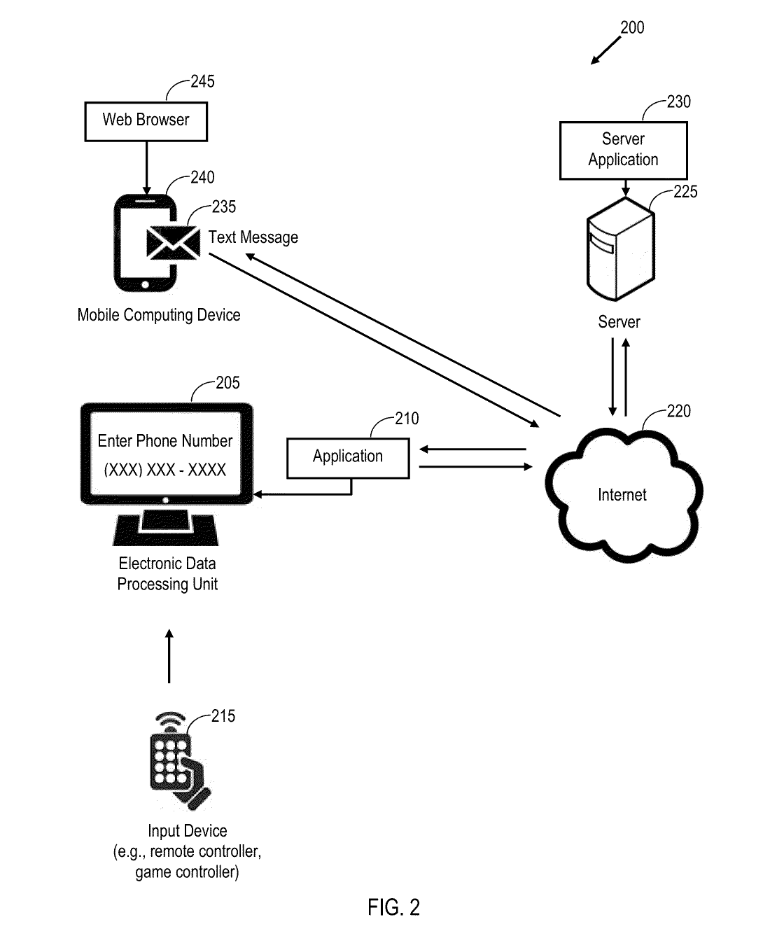

FIG. 1 shows the first step of one embodiment of the computer-based method 100, which is providing an application and a server application 105. The application and server application are preferably any computer readable instructions that cause a processor to perform the methods and processes disclosed herein when the instructions are executed by a processor. Specifically, the application 210 (shown in FIG. 2) is preferably configured to run on an electronic computing device 205 (shown in FIG. 2) such as an electronic data processing unit, computer system, gaming console, and/or mobile computing device, and is preferably configured to prompt a user to enter his or her phone number. The application is also preferably configured to send data such as the user's phone number to the server application 225 (shown in FIG. 2). The server application 225 is preferably any software application that is configured to perform one or more particular online tasks and is generally communicatively connected through the Internet via a server or electronic data processing unit. The server application 230 may be a web server that is capable of receiving and sending hypertext transfer protocol (HTTP) requests or a web container that preferably provides an environment for servlets and Java Server Pages (JSP) to run. For example, the server application 225 may be a web-based application that utilizes a web browser as a client or a computer software application that is coded in a browser-supported programming language such as JavaScript, HyperText Markup Language (HTML), C#, or Java. Other examples of server application 225 may include, without limitation: online games; massive multiplayer online (MMO) games, Bea WebLogic applications, IBM® WebSphere applications, and Oracle® applications.

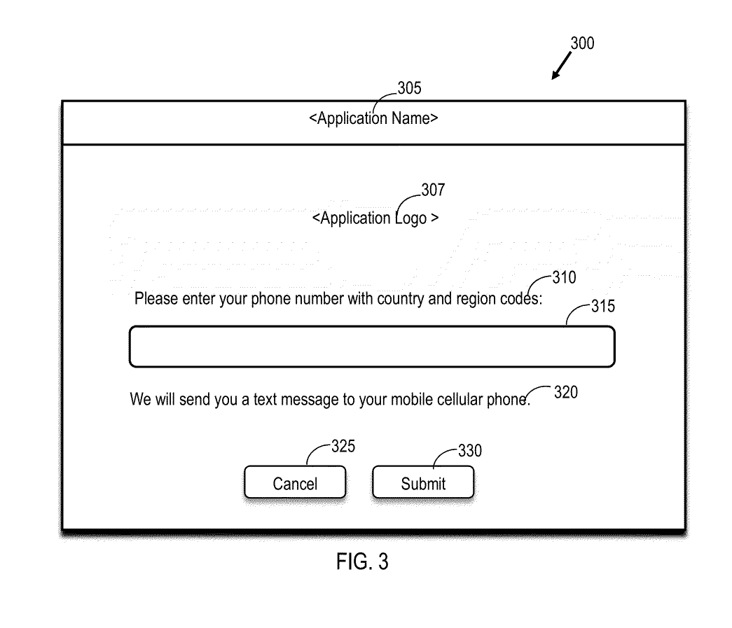

FIG. 1 shows the next four steps of the method 100, which are: displaying the application through a display screen of the electronic data processing unit to a user 110; prompting the user by the application to input a phone number of a mobile computing device into the application via an input device 115; receiving the phone number from the user 120; and sending the phone number by the application to the server application 125. Here, the application 210 is preferably displayed to the user through a display screen of the electronic data processing unit 205. In various embodiments, the application preferably has an interface and is preferably configured to display the interface to the user. Once displayed, the application 210 preferably prompts the user to input a phone number of a mobile phone or mobile computing device 240 into the application 210. The user may then enter his or her phone number into the input field 315 (shown in FIG. 3) of the application 210 by using an input device 215 to provide or send data and/or control signals from the input device 215 to the application 210. Such input devices may include, without limitation, a controller, a videogame controller (wired or wireless), a remote control, a keyboard, a mouse, and the like. Once the phone number is entered by the user, the application 210 preferably receives the phone number from the user and sends the phone number to the server application 230.

After the application 210 receives the phone number information from the user, the server application 230, also referred to as online software, preferably performs the next step—i.e., generating and transmitting a text message from the server application to the mobile computing device based on the phone number 130. Using the phone number of the user, the server application 230 is preferably capable in generating, and preferably does generate, an automated text message 235 (shown in FIG. 2), which is sent to the mobile computing device 240 of the user. The text message 235 will preferably contain a universal resource link (URL) link that will be configured to open a web browser of the mobile computing device 240 and may contain other messages as well, such as instructions that prompt a user to open the URL link. In various embodiments, the text message may also contain images and additional information as to how to link and save user account information into the server application 230.

The computer-based method 100 then preferably performs the next two steps, which are prompting the user to open the URL link of the text message 135; and opening a webpage in a web browser in the mobile computing device when the user opens the URL link 140. As discussed above, the text message 235 in the mobile computing device 240 may comprise of one or more messages, asking the user to click or open the URL link in order to link or save user account information to the server 230. After the user opens the text message 235, the user preferably opens the URL link which preferably causes a webpage of the server application 230 to open in the mobile computing device 240. The webpage may be generated from various browsers of the mobile computing device 240 such as Microsoft® Internet Explorer®, Netscape®, Mozilla® Firefox®, Google® Chrome®, Safari®, and Opera®, and any other web browsing software from Android® and Apple® iPhone and iPad devices.

Once the webpage is opened, the server application 230 then preferably performs the next two steps, which are: prompting the user to input a user account information into the webpage 145 and receiving the user account information from the user by the server application when the user inputs the user account information into the webpage 150. Here, the server application 230 may prompt the user to input user account information to perform various online tasks such as creating a user account or making an online transaction or payment. Specifically, the webpage of the server application 230 may instruct the user to enter his or her contact information (e.g., name, address, phone number, email address) and may also enter his or her financial or billing information such as credit card number, billing address, security questions, and the like. Other user account information may also be entered such as information concerning the user account and information for identifying the particular end user of the mobile computing device 240. The user may also make a payment when entering his or her user account information into the webpage. In situations where additional security measures are incorporated, the method 100 may also include the additional step of requiring the user to verify his or her authority for accessing the server application 230. This may provide the user with a mechanism to establish a more secure network connection. The user may then enter his or her user account information, which may be received by the server application 230.

Finally, after the user has entered his or her user account information, the server application 230 preferably performs the final step of the method 100, shown in FIG. 1, which is saving the user account information in the server 155. Specifically, after the user has entered all of his or her user account information into the webpage of the mobile computing device 240, the user account information is preferably saved in the server application 240 and may be used for future transactions. Thus, the server application 230 may populate the user account information for future payments, and, in various embodiments, additional passwords or passcodes may be implemented for the user to access the server 225. For example, after the user has entered his or her user account information in the server 225 initially via the mobile computing device 240, the user account information is preferably saved on the server 225. Thus, when the user decides to make another transaction or payment on the application 210, the server application 230 preferably populates the user account information that was saved on the server 225 to make any future payments.

Although not shown in FIG. 1, another embodiment of the method 100 may comprise the additional step of sending a payment authorization request to the user by the application 210. Preferably, the application 210 may send a payment authorization request, which allows the application 210 to process one or more future payments based on the saved user account information of the user. Unlike other embodiments, where the user makes a payment directly through the webpage of the server application 230, the application 210 may perform additional steps or tasks after the user account information has been linked or saved within the server application 230. Specifically, the application 210 may send a payment authorization request to the user. The payment authorization request may include specific instructions such as to how to make a payment or how to log into the application 210 through the saved user account. This payment authorization request may be reviewed by the user and then responded by the user by making a payment through the application 210. The application 210 may then process one or more payments and then send the payments to the server application 230. In alternative embodiments, the server application 230 may send a second text message, which may include additional instructions as to how to make a payment through the application 210, server application 230, and/or mobile computing device 240. Although FIG. 1 shows only eleven steps, it should be understood that the present invention may comprise of any number of steps, and some steps may be performed at the same time or out of order without deviating from the scope of the invention.

FIG. 2 is a functional flow diagram of one embodiment of the system for linking user account information from a mobile computing device. As shown in FIG. 2, one embodiment of the system 200 may comprise: a server application 230; server 225; Internet 220; application 210; electronic data processing unit 205; input device 215; mobile computing device 240; text message 235; and web browser 245. As discussed above, the online software or server application 230 is preferably running on a server 225 and may be displayed to, or accessed by, an application 210 of the electronic data processing unit 205 and/or web browser 245 of the mobile computing device 240. The application 210 of the electronic data processing unit 205 such as a videogame console, computer, or mobile computing device (e.g., smartphone, tablet, etc. . . . ) preferably prompts the user to input the phone number of a mobile computing device 240 of the user. The phone number is preferably associated with the mobile computing device 240 of the user and is preferably inputted by using an input device 215, which may be a remote control, videogame controller (wired or wireless), keyboard, mouse, and the like. After the phone number preferably has been entered by the user, the application 210 preferably sends the phone number information inputted by the user or data relating thereto to the server application 230. The server application 230 then preferably receives the phone number from the user and generates and transmits a text message 235 with a URL link to the mobile computing device 240 based on the phone number. The text message 235 preferably includes a URL link and the server application 230 via the text message 235 may prompt the user to click or open the URL link of the text message 235.

Alternatively, the application 210 may also display on the display screen of the electronic data processing unit 105, a message for the user to open the URL link of the text message that was sent. Once the user opens the URL link, a web browser 245 preferably opens in the mobile computing device 240 of the user and preferably prompts the user to enter his or her user account information into the webpage of the web browser 245. The user then preferably enters his or her user account information such as contact information billing information into the web browser 245 and the user account information is preferably submitted to the server application 230 by the user. Additional tasks such as making an online payment may be incorporated in the method 100 and system 200 when the user submits the user account information into the webpage of the web browser 245. After the user account information is entered, the user may then make one or more future payments into the application 210 without reentering his or her user account information into the application 210, webpage of the web browser 245, and/or server application 230.

FIG. 3 is a screenshot of one embodiment of the application of the electronic data processing unit and shows the application prompting the user to input a phone number of a mobile computing device. As shown in FIG. 3, one embodiment of the application 300 may comprise: an application name 305; application logo 307; instructions 310; input field 315; explanatory text 320; cancel button 325; and submit button 330. The application name 305 is preferably a word, name, and/or symbol by which the application 210, 300 is referred to. The application logo 307 is preferably the logo of the application 210, 300 but may also be the trademark or logo of the company. The instructions 310 are preferably one or more words used to prompt the user to input his or her phone number into the input field 315 and may be supplemented by explanatory text 320, which may be further used to describe the reasons for inputting the phone number of the user into the application 210, 300. Once the user has entered his or her phone number, the user may press the submit button 330 to confirm or submit the phone number to the application 210, 300 in order for the server application 230 to send a text message to the mobile computing device 240 of the user. Otherwise, the user may cancel the process by simply selecting the cancel button 325.

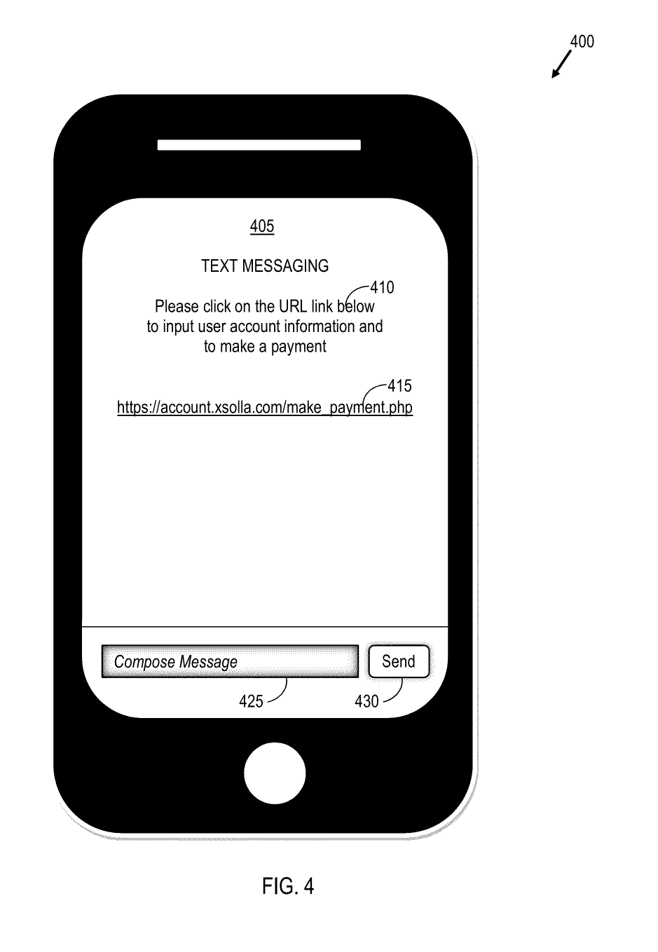

FIG. 4 is an illustration of one embodiment of a mobile computing device and shows a text message with a URL link sent by the server application. As shown in FIG. 4, one embodiment of the mobile computing device 400 may comprise a text message 405, wherein the text message 405 may further comprise: an instruction 410; a URL link 415; an input field 420; and a send button 425. The instruction 410 preferably provides directions or prompts a user to click or open the URL link 415. The URL link 415 preferably opens up the web browser 245 of the mobile computing device 240 and opens up a particular webpage where the user can enter his or her account information. As discussed above, the user account information may comprise contact information of the user (e.g., name, address, phone number, email address, etc. . . . ), billing information (e.g., credit card information, bank account information, PayPal® information, etc. . . . ) and other information such as username and password information. The input field 420 is preferably a field where a user can input a message for a reply text message and the send button is preferably the button used to send the reply text message.

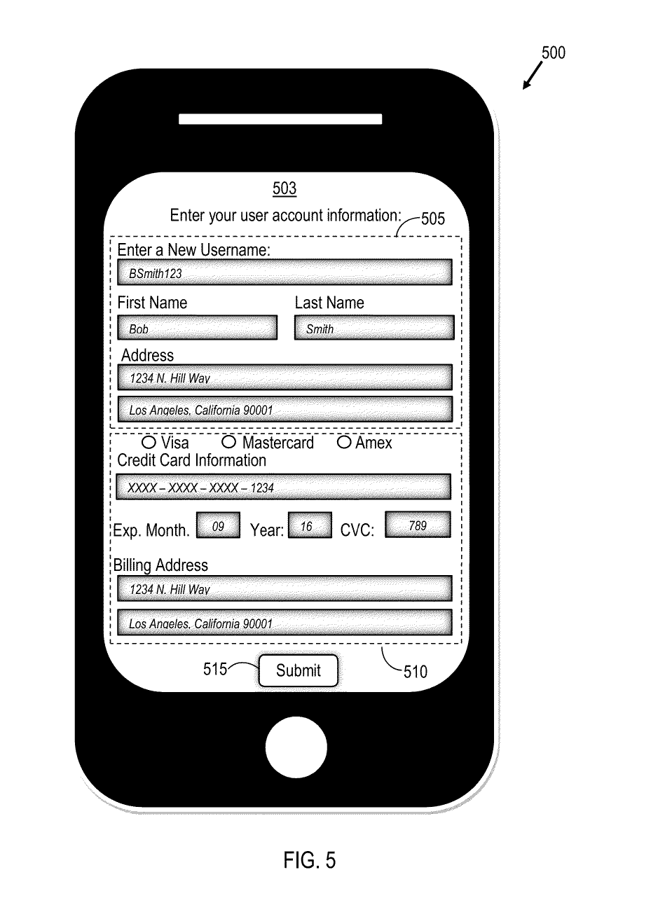

FIG. 5 is an illustration of another embodiment of a mobile computing device and shows a webpage where a user may enter user account information. As shown in FIG. 5, another embodiment of a mobile computing device 500 may comprise a webpage 503. The webpage 503 may comprise user account information such as contact information 505 and billing information 510. Specifically, as discussed above, the contact information 505 may comprise a name and address (e.g., residential address or commercial address) of the user, and the billing information 510, which may comprise credit card information (e.g., credit card number, expiration date, CVC number) and billing address of the user. Once all the user account information has been entered, the user may press the submit button 515 to submit the user account information into the webpage and server application 230. Although FIG. 5 only shows a contact information 505 and billing information 510, additional user account information may be included such as telephone number (e.g., home phone number, cell phone number, facsimile number, etc. . . . ), email address, and other personal information without deviating from the scope of the invention.

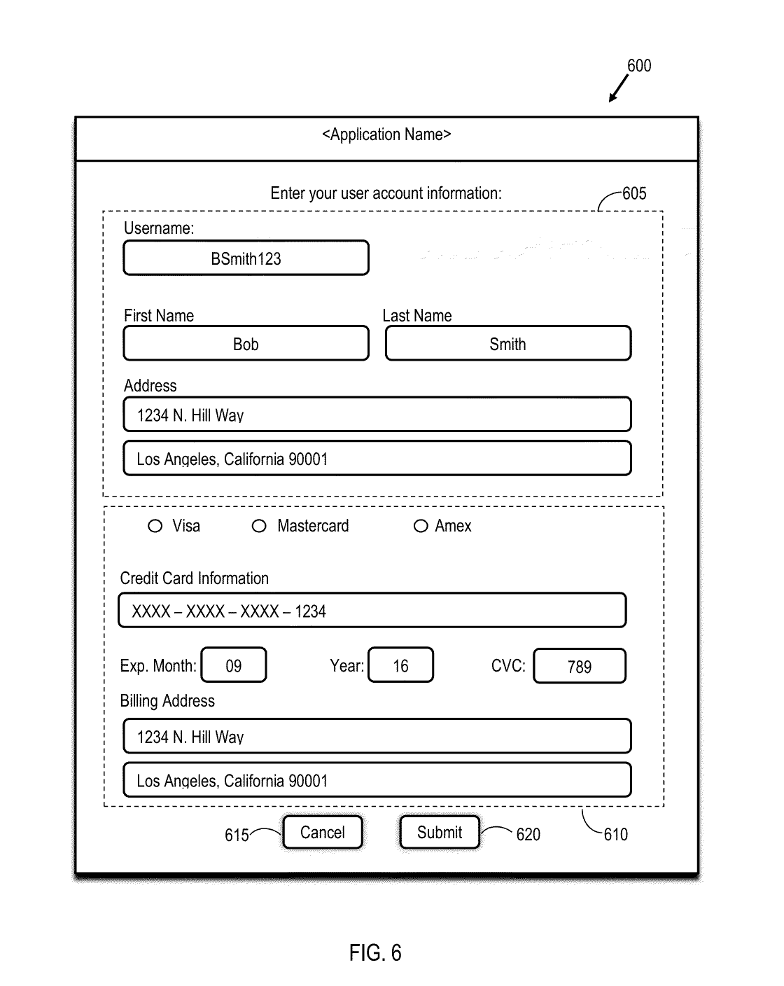

FIG. 6 is a screenshot of another embodiment of the application of the electronic data processing unit and shows that the user account information populated in the application by the server. As shown in FIG. 6, another embodiment of the application 600 may comprise contact information 605, billing information 610, cancel button 615, and submit button 620. FIG. 6 shows that the user account information that was previously entered in the web browser 245 of the mobile computing device 240 (i.e., webpage of the server application 230) may be populated in the application 210, 300, 600 by the server application 230. Specifically, the contact information 605 such as the name, address, and billing information 610 of the user may be auto-populated in the application 210, 300, 600, such that the user may edit or confirm the user account information. Alternatively, the user may be presented with a screen where the user may simply accept a payment transaction without viewing or edit such user account information. Thus, although FIG. 6 shows that the server application 230 and/or application 210, 300, 600 populating user account information for the user to confirm or edit, it should be understood that the method 100 may also not include the populating step without deviating from the scope of the invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for linking user account information for making future payments, the computer-implemented steps comprising:
providing an application and a server application;
wherein said application is configured to run on an electronic data processing unit;
wherein said server application is configured to run on a server;
wherein said application is configured to access said server application through a network;
displaying said application through a display screen of said electronic data processing unit;
prompting a user by said application to input a phone number of a mobile computing device into said application via an input device;
receiving, by said application, said phone number from said user;
sending said phone number by said application to said server application;
receiving by said server application said phone number from said user;
generating and transmitting a text message from said server application to said mobile computing device based on said phone number;
wherein said text message comprises a uniform resource locator (URL) link;
prompting said user to open said URL link;
opening a webpage in a web browser in said mobile computing device when said user opens said URL link;
prompting said user to input a user account information into said webpage;
receiving said user account information from said user by said server application when said user inputs said user account information into said webpage; and
saving said user account information in said server.

2. The method according to claim 1, wherein said application is an online game.

3. The method according to claim 1, wherein said electronic data processing unit is a gaming console.

4. The method according to claim 1, wherein said receiving step of said phone number of said user by said server application further comprises the steps of:
receiving, by said application said phone number from said user; and
sending said phone number by said application to said server application.

5. The method according to claim 4, further comprising the step of:
validating said payment of said user-by said server application.

6. The method according to claim 1, wherein said user account information is used to make one or more future payments through said application.

7. The method according to claim 1, the steps further comprising:
sending a payment authorization request to said user by said application;
wherein said payment authorization request allows said application to process one or more future payments based on said saved user account information of said user.

8. The method according to claim 1, wherein said user account information comprises a billing information of said user.

9. The method according to claim 1, wherein said user account information comprises a contact information of said user.

10. The method according to claim 1, wherein said mobile computing device is selected from the group of mobile computing devices consisting of: a cellphone; a tablet computer; and a smartphone.

11. The method according to claim 1, wherein said input device is selected from the group of input devices consisting of: a remote control; a keyboard; a video game controller; and a mouse.

12. A method for linking user account information for making future payments, the computer-implemented steps comprising:
providing an application and a server application;
wherein said application is configured to run on an electronic data processing unit;
wherein said server application is configured to run on a server;
wherein said application is configured to access said server application through a network;
displaying said application through a display screen of said electronic data processing unit;
prompting a user by said application to input a phone number of a mobile computing device into said application via an input device;
receiving, by said application said phone number from said user;
sending said phone number by said application to said server application;
receiving by said server application said phone number of said user;
generating and transmitting a text message from said server application to said mobile computing device based on said phone number;
wherein said text message comprises a uniform resource locator (URL) link;
prompting said user to open said URL link;
opening a webpage in a web browser in said mobile computing device when said user opens said URL link;
prompting said user to input a user account information into said webpage in order to make a payment;
receiving said user account information from said user by said server application when said user inputs said user account information into said webpage to make said payment;
saving said user account information in said server; and
creating a user account based on said saved user account information in said server;
wherein said user account is used to make one or more future payments through said application.

13. The method according to claim 12, wherein said application is an online game.

14. The method according to claim 12, wherein said electronic data processing unit is a gaming console.

15. The method according to claim 12, the steps further comprising:
sending a payment authorization request to said user by said application;
wherein said payment authorization request allows said application to process said one or more future payments based on said user account of said user.

16. The method according to claim 12, wherein said user account information comprises a billing information of said user.

17. The method according to claim 12, wherein said user account information comprises a contact information of said user.

18. The method according to claim 12, wherein said mobile computing device is selected from the group of mobile computing devices consisting of: a cellphone; a tablet computer; and a smartphone.

19. The method according to claim 12, wherein said input device is selected from the group of input devices consisting of: a remote control; a keyboard; a video game controller; and a mouse.

20. A method for linking user account information for making future payments, the computer-implemented steps comprising:
providing an online game and a server application;
wherein said online game is configured to run on an gaming console;
wherein said server application is configured to run on a server;
wherein said online game is configured to access said server application through a network;
displaying said online game through a display screen of said gaming console;
prompting a user by said online game to input a phone number of a mobile computing device into said online game via an input device;
receiving said phone number from said user;
sending said phone number by said online game to said server application;
receiving by said server application said phone number of said user;
generating and transmitting a text message from said server application to said mobile computing device based on said phone number;
wherein said text message comprises a uniform resource locator (URL) link;
prompting said user to open said URL link;
opening a webpage in a web browser in said mobile computing device when said user opens said URL link;
prompting said user to input a user account information into said webpage in order to make a payment;
receiving said user account information from said user by said server application when said user inputs said user account information into said webpage to make said payment;
saving said user account information in said server; and
sending a payment authorization request to said user by said online game;
wherein said payment authorization request allows said online game to process said one or more future payments based on said user account information of said user;
wherein said user account information comprises a billing information of said user;
wherein said user account information comprises a contact information of said user;
wherein said mobile computing device is selected from the group of mobile computing devices consisting of: a cellphone; a tablet computer; and a smartphone; and
wherein said input device is selected from the group of input devices consisting of: a remote control; a keyboard; a video game controller; and a mouse.
